(19) United States
(12) Patent Application Publication
(10) Pub. No.: US 2026/0283174 A1
(43) Pub. Date: Sep. 24, 2026

(54) AERATED CREAMERS, PACKAGED READY-TO-USE AERATED CREAMERS, AND METHODS OF MAKING AND USING SUCH CREAMERS

(71) Applicant: SOCIETE DES PRODUITS NESTLE S.A., Vevey (CH)

(72) Inventors: Ningrong Catherine FU, Dublin, OH (US); James STONE, Westerville, OH (US); Emanuel Jose DE FREITAS, Dublin, OH (US)

(21) Appl. No.: 19/690,463

(22) Filed: May 28, 2026

Related U.S. Application Data
(62) Division of application No. 18/545,906, filed on Dec. 19, 2023.
(60) Provisional application No. 63/434,552, filed on Dec. 22, 2022.

(51) Int. Cl. A23C 9/156; A23F 5/14; A23L 2/54

(52) U.S. Cl. CPC A23C 9/156; A23F 5/14; A23L 2/54

(57) ABSTRACT

An aerated creamer contains: a lipid selected from the group consisting of coconut oil, hydrogenated vegetable oil, hydrogenated palm oil, and a combination of saturated fat and liquid fat; a first emulsifier selected from the group consisting of diacetyl tartaric acid ester of mono-diglycerides (DATEM), mono-glycerides, di-glycerides, lecithin, and mixtures thereof; a second emulsifier selected from the group consisting of polyoxyethylene-20 sorbitan monooleate (Polysorbate 80), lactic acid esters of mono- and diglycerides (LACTEM), and mixtures thereof; and a stabilizer blend comprising cellulose and kappa-carrageenan. The aerated creamer has an overrun of 105-135%. A method of making a foamy beverage includes adding the aerated creamer to an iced or hot coffee. A packaged product includes a container; and the aerated creamer, sealed in the container. A method of making a foamy beverage includes opening the container of the packaged product; and adding the aerated creamer from the opened container to an iced or hot coffee.

### CROSS-REFERENCE TO RELATED APPLICATIONS

The present application is a divisional of U.S. patent application Ser. No. 18/545,906 filed Dec. 19, 2023, which claims priority to U.S. Provisional App. No. 63/434,552 filed Dec. 22, 2022, the entire contents of which are incorporated herein by reference.

### BACKGROUND

The present disclosure relates generally to aerated creamers, packaged ready-to-use aerated creamers, and methods of making and using such creamers. More specifically, the present disclosure is directed to aerated creamers that are shelf-stable with refrigeration for at least three months, and can be scooped from a container and placed on top of a cold or hot beverage, such as coffee, and then float on top of the beverage.

Creamers are widely used as whitening agents with hot and cold beverages such as, for example, coffee, cocoa, malt beverages and tea. Creamers are commonly used instead of milk or cream and typically can be in liquid or powder forms. Creamers may have a variety of different flavors and provide mouthfeel, whitening, body, and a smooth texture.

Consumers enjoy freshly prepared foamed “milks” which are poured on top of hot or cold beverages. The “milks” may be conventional dairy milk, but can also be plant-based milks such as almond or soy milk. The foamed milks are appreciated for their indulgent texture and/or mouthfeel. However, this texture depends strongly on gas dispersion properties of the foamed milk, such as bubble size and distribution, and the origin of the bubbles. Freshly foamed milks are generally prepared using mechanical mixers or steam wands and have a foam which collapses after a few minutes. Such foams are not suitable as portable packaged beverage products with long term storage.

In recent years, packaged liquid creamers have gained a significant popularity. However, to avoid biological spoilage, packaged liquid creamers typically are subjected to heat treatment by the manufacturer, which has a strong impact on stability and may provoke gelation, syneresis and other undesirable physical evolution over shelf life. In addition, liquid creamers may not provide a strong and stable foam when processed by mechanical mixers, steam wands or other similar tools.

Creamers may be packaged in pressurized cans with a propellant gas such as nitrous oxide which provides a foam when the liquid creamer passed through a dispensing nozzle. Typically the foam is stabilized by fat globules, in a similar manner to whipping cream. However, pressurized cans are heavy and relatively expensive.

### SUMMARY

To the best knowledge of the present inventors, whipped or foamed toppings for coffee are only marketed frozen or in an aerosol can, and at the time of the present disclosure, there was no refrigerated, ready-to-use foamed or whipped topping packaged in a tub with a shelf-life of at least three months. The present disclosure provides creamers that are high in saturated fat and contain an optimized blend of protein, emulsifiers and stabilizers to create whippable emulsion. The emulsion is subjected to an aerator to create a whipped creamer that can be packaged in containers, such as 16 oz. plastic tubs, and then refrigerated; and the packaged aerated creamer can be stable over a shelf life of at least three months without major disruption of the creamer's whipped structure.

Without being bound by any theory, the present inventors believe that the specific combination of a saturated fat that is a solid at room temperature, such as coconut oil; the relatively high concentration of saturated fat in the creamer; the ratio of emulsifier to oil; the ratio of the particular emulsifiers to each other; and the concentration of stabilizers, achieve a whippable creamer that then is scoopable and maintains its viscosity and texture over time as refrigerated and a capability to float on a beverage such as hot or cold coffee.

Further in this regard, the present inventors believe the hydrophobic/lipophilic balance of the emulsifiers is notable, in that the combination of diacetyl tartaric acid ester of mono-diglycerides (DATEM) and polyoxyethylene-20 sorbitan monooleate (Polysorbate 80) can achieve stabilizing and destabilizing effects in an oil-in-water emulsion, such that fat globules in the creamer after partial crystallization can partially coalesce when whipped to stabilize air bubbles in final structure.

Accordingly, an advantage of one or more embodiments according to the present disclosure is a completely new product format for a creamer.

Another advantage of one or more embodiments according to the present disclosure is a ready-to-use aerated creamer that has a longer shelf-life than conventional aerated creamers, without needing to be frozen, and that can dissolve in hot or iced coffee for consumption.

Yet another advantage of one or more embodiments according to the present disclosure is an aerated creamer that does not need an aerosol can or production by complex equipment.

Additional features and advantages are described herein and will be apparent from the following Detailed Description and the Figures.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a side perspective view of a coffee with an embodiment of an aerated creamer provided by the present disclosure.

FIG. 2 is a table showing a non-limiting example formulation of an embodiment of an aerated creamer provided by the present disclosure.

FIG. 3 is a graph showing results from a laboratory study disclosed herein.

FIG. 4 is a graph showing results from a larger scale study disclosed herein.

### DETAILED DESCRIPTION

As used in this disclosure and the appended claims, the singular forms “a,” “an” and “the” include plural referents unless the context clearly dictates otherwise. Thus, for example, reference to “an emulsifier” or “the emulsifier” includes one emulsifier and also two or more emulsifiers.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

However, the devices and apparatuses disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Furthermore, the disclosure of an optional component or step encompasses a disclosure of an embodiment in which the optional component or step is absent.

The term “and/or” used in the context of “X and/or Y” should be interpreted as “X,” or “Y,” or “X and Y.” “At least one of X or Y” should be interpreted similarly. For example, “dairy protein and/or dairy substitute” and “at least one dairy protein or dairy substitute” are disclosures of “dairy protein without dairy substitute,” “dairy substitute without dairy protein,” and “both dairy protein and dairy substitute.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

All percentages expressed herein are by weight of the total weight of the composition (without including air) unless expressed otherwise. As used herein, “about” and “approximately” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. All numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

In the context of this disclosure, a “creamer” means an edible composition that can be added to a liquid beverage, such as coffee or tea, preferably as a foamy topping according to the present disclosure. Preferably the creamer comprises at least one dairy protein or dairy substitute. Non-limiting examples of suitable dairy proteins include one or more of cream, full fat milk, skimmed milk, buttermilk, whey (for example sweet whey), casein (for example micellar casein) and combinations thereof. Non-limiting examples of suitable dairy substitutes include one or more plant proteins, for example soy protein, rice protein, pea protein, chickpea protein, potato protein, canola protein, hemp protein, oat protein, flaxseed protein, faba bean protein, lentil protein, and combinations thereof. The plant protein may be hydrolysed in some embodiments. A “ready-to-use” creamer means the creamer is formulated to be added to a beverage, such as an iced or hot coffee, without addition of any other ingredients and without any physical processing such as whipping, heating or cooling the creamer between removal from the container and addition to the beverage. The aerated creamer may not be frozen. The consumer may optionally stir the aerated creamer before addition to the beverage, but preferably stirring by the consumer is not required.

The term “overrun” refers to the increase in volume of the creamer from aeration and is calculated according to the following equation:

$$Overrun ( OR ) = ( ( {V}_{a} - {V}_{b} ) l {V}_{b} ) \times 100$$

where V_{b} is the volume of a predetermined weight of the creamer before aeration or whipping, and Vₐ is the volume of the same weight of the creamer after aeration or whipping.

As used herein, a “container” is any device comprising an at least partially enclosed interior capable of holding an edible composition and comprising an opening from which at least a portion of the edible composition can be removed from the interior of the container. Non-limiting examples of suitable containers include bottles and jars, and a preferred embodiment is a plastic tub. A “tub” is a container that has a bottom which is at least partially planar, and the tub has an opening opposite the bottom, the opening preferably having approximately the same dimensions as the bottom, and the tub preferably having a cylindrical or cuboid shape.

The aerated creamer of the invention may be shelf-stable. As used herein, “shelf-stable” means that the aerated creamer maintains approximately the same viscosity over at least three months of storage in refrigeration, such as 3° C. to 5° C. in a refrigerator, for example for three to six months at refrigeration. It should be noted that the meaning of the term “shelf stable” in the current specification does not necessarily match definitions of the term that might be applied in various jurisdictions around the world, e.g. for the purpose of food labelling.

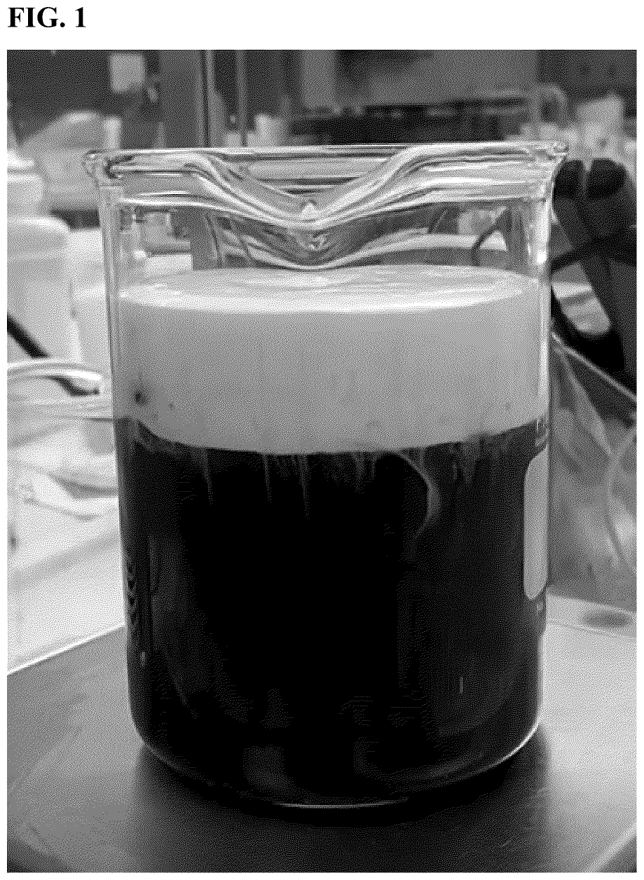

FIG. 1 shows an embodiment of an aerated creamer according to the present disclosure, added on top of a coffee and floating on the top of the coffee. The aerated creamer has an overrun of 105-135 wt. %, for example about 120% overrun. Higher overruns may be used in some embodiments, for example up to 150% overrun, but may negatively affect dissolution in cold coffee. Preferably the aerated creamer is provided in a container and is ready-to-use such that it can be added directly from the container to a beverage, for example by scooping with a spoon.

The aerated creamer comprises a lipid, for example a fat. In the context of the present invention, the term fat refers to triglycerides. Fats are the chief component of animal adipose tissue and many plant seeds. Fats which are generally encountered in their liquid form at ambient temperature are commonly referred to as oils. In the present invention the terms oils and fats are interchangeable. The aerated creamer comprises a lipid which preferably comprises coconut oil. Coconut oil is a saturated fat that crystallizes at relatively low temperatures and thus is typically a solid at room temperature. Alternatively or additionally, the lipid in the aerated creamer may comprise a hydrogenated vegetable oil, that may have a substantially similar melting curve or crystallization curve as coconut oil. In some embodiments, the lipid in the aerated creamer comprises a blend of saturated and unsaturated fat having a substantially similar melting curve or crystallization curve as coconut oil, additionally to or instead of the coconut oil. In some embodiments, the lipid has a solid fat content at 10° C. greater than 70%, for example greater than 80% and a solid fat content at 20° C. greater than 5%, for example greater than 10%. The solid fat content may be measured by low resolution nuclear magnetic resonance, for example AOCS Official Method Cd 16b-93 Rev 2022—Method I nonstabilizing fats and oils.

The lipid which is preferably coconut oil, and/or hydrogenated vegetable oil, (more preferably at least coconut oil, most preferably only coconut oil) may be present in the aerated creamer in a total amount of 20.0 to 40.0 wt. % of the aerated creamer, preferably 22.5 to 32.5 wt. % of the aerated creamer, more preferably 25.0 to 30.0 wt. % of the aerated creamer.

The aerated creamer comprises an emulsifier blend comprising a first emulsifier and a second emulsifier. The first emulsifier may be selected from the group consisting of monoglycerides, diglycerides, lecithin, diacetyl tartaric acid ester of mono-diglycerides (DATEM, e.g., from soy, palm and/or rapeseed oils), and mixtures of thereof, and preferably comprises at least DATEM, most preferably only DATEM and monoglycerides. The second emulsifier may be selected from the group consisting of lactic acid esters of mono- and diglycerides (LACTEM), polyoxyethylene-20 sorbitan monooleate (Polysorbate 80), and mixtures of thereof, and preferably comprises at least Polysorbate 80, most preferably only Polysorbate 80. In some embodiments, the DATEM, monoglycerides and Polysorbate 80 are the only emulsifiers in the aerated creamer. In some embodiments, the DATEM and the Polysorbate 80 are the only emulsifiers in the aerated creamer.

In a particularly preferred embodiment, the aerated creamer has a weight ratio of DATEM+monoglycerides:Polysorbate 80 in the range of 2.0:1 to 3.0:1, more preferably 2.25:1 to 2.75:1. In a particularly preferred embodiment, the aerated creamer has a weight ratio of (DATEM+monoglycerides+Polysorbate 80):coconutoil in the range of 1:50 to 1:60, more preferably 1:52 to 1:58.

The aerated creamer comprises a stabilizer blend comprising cellulose and kappa-carrageenan. The cellulose preferably comprises at least one of microcrystalline cellulose (MCC) and carboxymethyl cellulose (CMC), more preferably both MCC and CMC. In some embodiments, the cellulose is 0.05 to 0.40 wt. % of the aerated creamer, preferably 0.10 to 0.30 wt. % of the aerated creamer, more preferably 0.15 to 0.25 wt. % of the aerated creamer. In some embodiments, the kappa-carrageenan is 0.060 to 0.100 wt. % of the aerated creamer, preferably 0.065 to 0.090 wt. % of the aerated creamer, more preferably 0.070 to 0.080 wt. % of the aerated creamer. In some embodiments, the cellulose and the kappa-carrageenan are the only stabilizers in the aerated creamer.

The aerated creamer is not a powder. As used herein, a “powder” is a plurality of dried solid particles. Preferably, the aerated creamer is not frozen.

The aerated creamer can be produced by mixing the ingredients and water and then aerating the mixture, for example in a machine that creates shear force (whipping effect) together with gas (any gas) injection, such as an Aeromix® aerator, a Mondomix® aerator or a TetraPak® freezer machine. For example, the mixture can be aerated by combining two streams, one for the creamer and the other for the air, such that the aerated creamer is formed. Additionally or alternatively to air, the creamer may be aerated by nitrogen. Depending on the specific aerator, the air can be in an amount of 100 to 200 vl. % of the creamer, and the mixing speed of creamer-air mixture can be 800 to 1000 rpm.

In some embodiments, the aerated creamer optionally comprises a protein such as micellar casein in an amount of 0.1 to 10.0 wt. % of the aerated creamer, preferably 0.2 to 7.5 wt. % of the aerated creamer, more preferably 0.5 to 5.0 wt. % of the aerated creamer, most preferably 1.5 to 2.5 wt. % of the aerated creamer.

In some embodiments, the aerated creamer optionally comprises one or more additional ingredients such as flavors, sweeteners, colorants, antioxidants (e.g. lipid antioxidants), or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In an embodiment, a sweetener such as sucrose is 5 wt. % to 35% wt. % of the aerated creamer, preferably 10% wt. % to 25% wt. % of the aerated creamer, most preferably about 15 wt. % of the aerated creamer.

In some embodiments, the aerated creamer optionally comprises at least one buffering agent. Non-limiting examples of suitable buffering agents include a food grade salt of organic or inorganic acid selected from the group consisting of potassium phosphate, dipotassium phosphate, tripotassium phosphate, sodium phosphate, di sodium phosphate, trisodium phosphate, sodium tripolyphosphate, potassium tripolyphosphate, tetra sodium pyrophosphate, tetra potassium pyrophosphate, sodium hexametaphosphate, potassium carbonates, sodium carbonates, potassium bicarbonates, sodium bicarbonates, sodium or potassium acetate, sodium or potassium ascorbate, and a combination thereof. The at least one buffering agent such as dipotassium phosphate may be 0.05% to 3.5% by weight of the aerated creamer, preferably 0.10% wt. % to 1.0% wt. % of the aerated creamer, most preferably 0.30% wt. % to 0.70% wt. % of the aerated creamer.

In some embodiments, the aerated creamer optionally comprises sodium chloride, which may enhance sweetness. The sodium chloride may be 0.05% to 1.5% by weight of the aerated creamer, preferably 0.10% wt. % to 1.0% wt. % of the aerated creamer, most preferably 0.20% wt. % to 0.6% wt. % of the aerated creamer.

In view of the disclosures herein, particularly preferred embodiments of the aerated creamer comprise:
a lipid selected from the group consisting of coconut oil, hydrogenated vegetable oil, and a combination of saturated and unsaturated fat;
a first emulsifier selected from the group consisting of diacetyl tartaric acid ester of mono-diglycerides (DATEM), mono-glycerides, di-glycerides, lecithin and mixtures thereof;
a second emulsifier selected from the group consisting of lactic acid esters of mono- and diglycerides (LACTEM), polyoxyethylene-20 sorbitan monooleate (Polysorbate 80), and mixtures thereof; and
a stabilizer blend comprising cellulose and kappa-carrageenan,
wherein the aerated creamer has an overrun of 105-135%.

In some embodiments, the lipid comprises coconut oil, preferably at an amount of 25.0 to 30.0 wt. % of the aerated creamer.

In some embodiments, the first emulsifier comprises DATEM and monoglycerides, and/or the second emulsifier comprises Polysorbate 80. In some embodiments, the first emulsifier comprises DATEM, and/or the second emulsifier comprises Polysorbate 80. A weight ratio of (DATEM+Monoglycerides):Polysorbate 80 may be about 2.5:1, and/or a weight ratio of (DATEM+Monoglycerides+Polysorbate 80):coconutoil may be about 1:55. A weight ratio of DATEM:Polysorbate 80 may be about 2.5:1, and/or a weight ratio of (DATEM+Polysorbate 80):coconutoil may be about 1:55.

In some embodiments, the overrun is about 120%.

In some embodiments, the aerated creamer further comprises at least one additional component selected from the group consisting of water, a sweetener, a buffer salt, a flavor, a color, sodium chloride, and mixtures thereof. Additionally or alternatively, optionally the aerated creamer further comprises a protein.

In some embodiments, the aerated creamer is not frozen.

In some embodiments, the aerated creamer is not a powder.

Another aspect of the present disclosure is a method of making a foamy beverage, the method comprising adding any of the aerated creamers to an iced or hot coffee. In some embodiments, a consumer adds the aerated creamer to the iced or hot coffee, and the aerated creamer is provided separately from the iced or hot coffee. In some embodiments, the consumer stores the aerated creamer at refrigeration temperatures prior to adding the aerated creamer to the iced or hot coffee; and the aerated creamer is not subjected to any freezing by the consumer, is not stored in an aerosol can, and is not added to the iced or hot coffee by an aerosol can. Preferably the adding of the aerated creamer to the iced or hot coffee by the consumer does not use an actuator and does not subject the aerated creamer to a propellant. Non-limiting examples of a propellant preferably excluded from being applied to the aerated creamer during consumer use are one or more of carbon dioxide, nitrogen, nitrous oxide, dinitrogen, dinitrogen oxide, butane, isobutane, propane, octafluorocyclobutane, and mixtures thereof. For example, in some embodiments, the adding of the aerated creamer to the iced or hot coffee comprises (or consists of) a consumer using a handheld utensil, such as a spoon, to move the aerated creamer into the iced or hot coffee and/or on the top of the iced or hot coffee.

Yet another aspect of the present disclosure is a packaged product comprising: a container; and the aerated creamer, sealed in the container.

And another aspect of the present disclosure is a method of making a foamy beverage, the method comprising: opening the container of the packaged product; and adding the aerated creamer from the opened container to an iced or hot coffee, preferably to a top of the iced or hot coffee such that at least a majority of the aerated creamer floats on the top of the iced or hot coffee. The aerated creamer may be stirred in the container before first use. In some embodiments, a consumer opens the container and adds the aerated creamer to the iced or hot coffee, and the aerated creamer is provided separately from the iced or hot coffee. In some embodiments, the consumer stores the aerated creamer at refrigeration temperatures prior to adding the aerated creamer to the iced or hot coffee; and the aerated creamer is not subjected to any freezing by the consumer, is not stored in an aerosol can, and is not added to the iced or hot coffee by an aerosol can. The aerated creamer may be added directly to the iced or hot coffee without adding any other ingredients to the aerated creamer and without whipping the aerated creamer, after the storing at the refrigeration temperatures. The aerated creamer may be added directly to the iced or hot coffee without adding any other ingredients to the aerated creamer and without whipping, heating or cooling the aerated creamer, after the storing at the refrigeration temperatures. Preferably, the container does not include an actuator and is not associated with an actuator. Preferably, the container does not contain any propellant in addition to the aerated creamer and does not subject the aerated creamer to a propellant. For example, in some embodiments, the adding of the aerated creamer to the iced or hot coffee comprises (or consists of) a consumer using a handheld utensil, such as a spoon, to move the aerated creamer from the opened container into the iced or hot coffee and/or on the top of the iced or hot coffee.

Yet another aspect of the present disclosure is a method of providing an aerated creamer to a consumer, the method comprising: storing the packaged product, which comprises the container and the aerated creamer, at refrigeration temperatures; and providing the packaged product to the consumer after the storing at the refrigeration temperatures, wherein the packaged product is not subjected to any freezing before the providing to the consumer and is not stored in an aerosol can.

And another aspect of the present disclosure is a method of manufacturing an aerated creamer, for example any of the aerated creamers disclosed herein, the method comprising: mixing (i) water, (ii) a lipid selected from the group consisting of coconut oil, hydrogenated vegetable oil, hydrogenated palm oil, and a combination of saturated fat and liquid fat, (iii) a first emulsifier selected from the group consisting of diacetyl tartaric acid ester of mono-diglycerides (DATEM), mono-glycerides, di-glycerides, lecithin, and mixtures thereof, (iv) a second emulsifier selected from the group consisting of polyoxyethylene-20 sorbitan monooleate (Polysorbate 80), lactic acid esters of mono- and diglycerides (LACTEM), and mixtures thereof, and (v) a stabilizer blend comprising cellulose and kappa-carrageenan; an aerating the mixture to an overrun of 105-135% to form the aerated creamer, preferably by combining a first stream comprising the mixture and a second stream comprising air. In some embodiments, the mixture that is aerated to form the aerated creamer further comprises a protein and/or a buffering salt in the mixture.

### EXAMPLES

### Example 1

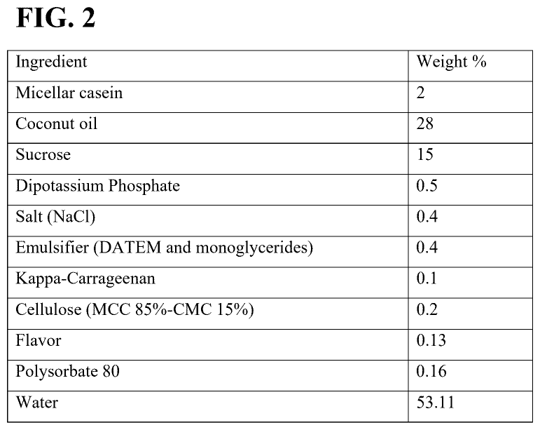

FIG. 2 is a table showing a non-limiting example formulation of an embodiment of an aerated creamer provided by the present disclosure. The aerated creamer was prepared by mixing the ingredients and water and then aerating the mixture in an Aeromix® aerator. The resulting creamer had an overrun of 120%.

### Example 2

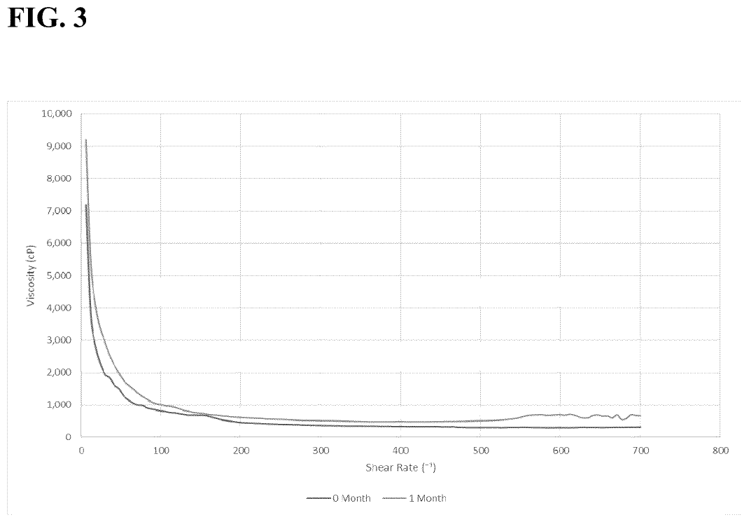

An experimental study was conducted on the aerated creamers provided by the present disclosure. The results are shown in FIG. 3 and demonstrate that the aerated creamers provided by the present disclosure are stable at refrigerated temperatures. Samples were stored at refrigerated temperature before a rheological measurement was taken each month. Samples were randomly picked each month from the same experimental production lot. For the rheological measurement, samples were placed in an Anton Paar MCR 501 rheometer at 4° C. The rheometer was fitted with a CC27-SN18942 Measuring System. Measurements of viscosity in cP were recorded for sheer rates between 0 and 700 s⁻¹. FIG. 3 shows the comparison of the viscosity when a sample was fresh (0 month) versus at 1 month. It can be seen that the rheology is essentially unchanged.

### Example 3

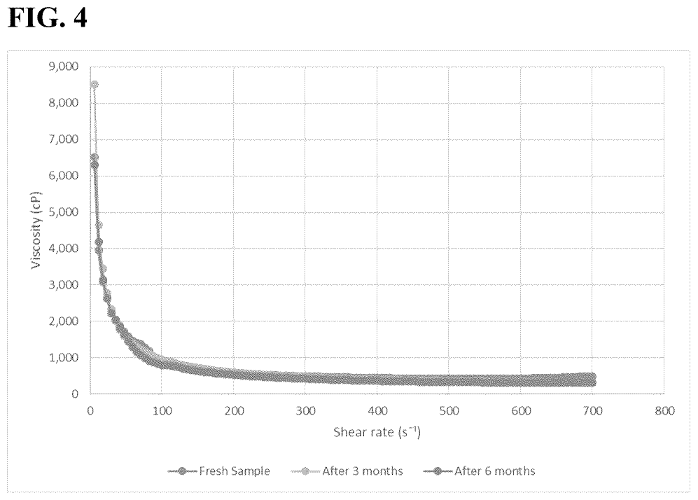

Following the lab-scale experiments and analyses discussed above, a larger-scale production was conducted. Samples of the aerated creamer disclosed herein were stored at a temperature of 4° C. for a duration of 6 months. Each month, a sample was randomly chosen from the same production batch and subjected to rheological measurements. These measurements were conducted using an Anton Paar MCR 501 rheometer at a temperature of 4° C. The rheometer was equipped with a CC27-SN18942 Measuring System. Viscosity measurements in cP were taken for sheer rates ranging from 0 to 700 s⁻¹. FIG. 4 illustrates a comparison of the product's viscosity between a fresh sample immediately after production, after 3 months, and after 6 months.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1: A method of making a foamy beverage, the method comprising adding an aerated creamer to an iced or hot coffee, the aerated creamer comprising:
a lipid selected from the group consisting of coconut oil, hydrogenated vegetable oil, and a combination of saturated and unsaturated fat;
a first emulsifier selected from the group consisting of diacetyl tartaric acid ester of mono-diglycerides (DATEM), mono-glycerides, di-glycerides, lecithin, and mixtures thereof;
a second emulsifier selected from the group consisting of polyoxyethylene-20 sorbitan monooleate (Polysorbate 80), Lactic acid esters of mono- and diglycerides (Lactem), and mixtures thereof; and
a stabilizer blend comprising cellulose and kappa-carrageenan, wherein the aerated creamer has an overrun of 105-135%.

2: The method of claim 1, wherein a consumer adds the aerated creamer to the iced or hot coffee, and the aerated creamer is provided separately from the iced or hot coffee.

3: The method of claim 1, wherein the consumer stores the aerated creamer at refrigeration temperatures prior to adding the aerated creamer to the iced or hot coffee; and the aerated creamer is not subjected to any freezing by the consumer, is not stored in an aerosol can, and is not added to the iced or hot coffee by an aerosol can.

4: The method of claim 1, wherein the adding of the aerated creamer to the iced or hot coffee does not use an actuator and does not subject the aerated creamer to a propellant.

5: A method of making a foamy beverage, the method comprising:
(i) opening a container comprising an aerated creamer sealed in the container, the aerated creamer comprising:
a lipid selected from the group consisting of coconut oil, hydrogenated vegetable oil, and a combination of saturated and unsaturated fat;
a first emulsifier selected from the group consisting of diacetyl tartaric acid ester of mono-diglycerides (DATEM), mono-glycerides, di-glycerides, lecithin, and mixtures thereof;
a second emulsifier selected from the group consisting of polyoxyethylene-20 sorbitan monooleate (Polysorbate 80), Lactic acid esters of mono- and diglycerides (Lactem), and mixtures thereof; and
a stabilizer blend comprising cellulose and kappa-carrageenan, wherein the aerated creamer has an overrun of 105-135%; and
(ii) adding the aerated creamer from the opened container to an iced or hot coffee, preferably to a top of the iced or hot coffee such that at least a majority of the aerated creamer floats on the top of the iced or hot coffee.

6: The method of claim 5, wherein a consumer opens the container and adds the aerated creamer to the iced or hot coffee, and the aerated creamer is provided separately from the iced or hot coffee.

7: The method of claim 5, wherein the consumer stores the aerated creamer at refrigeration temperatures prior to adding the aerated creamer to the iced or hot coffee; and the aerated creamer is not subjected to any freezing by the consumer, is not stored in an aerosol can, and is not added to the iced or hot coffee by an aerosol can.

8: The method of claim 7, wherein the aerated creamer is added directly to the iced or hot coffee without adding any other ingredients to the aerated creamer and without whipping, heating or cooling the aerated creamer, after the storing at the refrigeration temperatures.

9: A method of providing an aerated creamer to a consumer, the method comprising:
(i) storing a packaged product at refrigeration temperatures, the packaged product comprising:
a container; and
an aerated creamer sealed in the container, the aerated creamer comprising:
a lipid selected from the group consisting of coconut oil, hydrogenated vegetable oil, and a combination of saturated and unsaturated fat;
a first emulsifier selected from the group consisting of diacetyl tartaric acid ester of mono-diglycerides (DATEM), mono-glycerides, di-glycerides, lecithin, and mixtures thereof;
a second emulsifier selected from the group consisting of polyoxyethylene-20 sorbitan monooleate (Polysorbate 80), Lactic acid esters of mono- and diglycerides (Lactem), and mixtures thereof; and
a stabilizer blend comprising cellulose and kappa-carrageenan, wherein the aerated creamer has an overrun of 105-135%; and
(ii) providing the packaged product to the consumer after the storing at the refrigeration temperatures,
wherein the packaged product is not subjected to any freezing before the providing to the consumer and is not stored in an aerosol can.
